(19) United States
(12) Patent Application Publication
(10) Pub. No.: US 2022/0406131 A1
(43) Pub. Date: Dec. 22, 2022

(54) WARNING METHOD, APPARATUS, DEVICE AND COMPUTER STORAGE MEDIUM

(71) Applicant: SENSETIME INTERNATIONAL PTE. LTD., Singapore (SG)

(72) Inventors: Miao OUYANG, Singapore (SG); Xinxin WANG, Singapore (SG)

(21) Appl. No.: 17/363,403

(22) Filed: Jun. 30, 2021

Related U.S. Application Data
(63) Continuation of application No. PCT/IB2021/055678, filed on Jun. 25, 2021.

(30) Foreign Application Priority Data
Jun. 18, 2021 (SG) 10202106583R

(51) Int. Cl. G07F 17/32; G06K 9/00

(52) U.S. Cl. CPC G07F 17/3241; G06K 9/00744; G07F 17/322

(57) ABSTRACT

The embodiments disclose a warning method, apparatus, device and computer storage medium. The method includes that: multiple frames of images obtained by photographing a game table are acquired, the game table including a placement region configured for placing a token; and in a case of determining that a game enters a settlement stage based on at least one frame of first image in the frames of images, in response to determining, according to at least one frame of second image in the frames of images, that a gamer of the game changes the token in the placement region, warning information is output, the at least one frame of second image being shot in a case where the game enters the settlement stage.

### CROSS-REFERENCE TO RELATED APPLICATION

This is continuation application of international application PCT/IB2021/055678, filed on 25 Jun. 2021, which claims priority to Singaporean patent application No. 10202106583R filed with IPOS on 18 Jun. 2021. The contents of international application PCT/IB2021/055678 and Singaporean patent application No. 10202106583R are incorporated herein by reference in their entireties.

### TECHNICAL FIELD

Embodiments of the disclosure relate to, but are not limited to, gaming, and particularly to a warning method, apparatus, device and computer storage medium.

### BACKGROUND

After a result of a round of a game comes out, a game controller may usually collect tokens from a placement region of a gamer that loses at a game table, and deliver the tokens to a placement region of a gamer that wins.

To ensure the fairness in the game, after the game result comes out, gamers are not allowed to change tokens on the game table. However, after the game result comes out, a gamer often change tokens in the placement region configured for placing tokens on the game table, and the game controller pays unknowingly based on the tokens changed by the gamer in the placement region, which will easily cause losses to game places.

However, there is no technique of detecting actions of gamers in a game process in the related art.

### SUMMARY

The embodiments of the disclosure provide a warning method, apparatus, device and a computer storage medium.

In a first aspect, a warning method is provided, which may include the following operations.

Multiple frames of images obtained by photographing a game table are acquired, the game table including a placement region configured for placing a token.

In a case of determining, based on at least one frame of first image in the frames of images, that a game enters a settlement stage, in response to determining, according to at least one frame of second image in the frames of images, that the token in the placement region is changed by a gamer of the game, warning information is output, the at least one frame of second image being shot in a case where the game enters the settlement stage.

In a second aspect, a warning apparatus is provided, which may include: an acquisition unit configured to acquire multiple frames of images obtained by photographing a game table, the game table including a placement region configured for placing a token; and an outputting unit configured to, in a case of determining, based on at least one frame of first image in the frames of images, that a game enters a settlement stage, in response to determining, according to at least one frame of second image in the frames of images, that the token in the placement region is changed by a gamer of the game, output warning information, the at least one frame of second image being shot in a case where the game enters the settlement stage.

In a third aspect, a warning device is provided, which may include a memory and a processor. The memory may store a computer program capable of running in the processor. The processor may implement the steps in the above method when executing the computer program.

In a fourth aspect, a computer storage medium is provided, which may store one or more programs. The one or more programs may be executed by one or more processors to implement the steps in the above method.

In the embodiments of the disclosure, the warning information is output in a case of determining, based on the frames of images obtained by photographing the game table, that the token in the placement region is changed by the gamer in the settlement stage of the game, such that actions of the gamer are detected in the game process, and the gamer is prompted through the warning information to undo the action of changing the token in the settlement stage of the game. Therefore, the situation that actions, not conforming to game rules, of the gamer cause loss to a game place is reduced.

### BRIEF DESCRIPTION OF THE DRAWINGS

FIG. 1 is a structure diagram of a warning system according to an embodiment of the disclosure.

FIG. 2 is a flowchart of a warning method according to an embodiment of the disclosure.

FIG. 3 is a flowchart of another warning method according to an embodiment of the disclosure.

FIG. 4 is a flowchart of yet another warning method according to an embodiment of the disclosure.

FIG. 5 is a flowchart of still another warning method according to an embodiment of the disclosure.

FIG. 6 is a flowchart of a warning method according to another embodiment of the disclosure.

FIG. 7 is a flowchart of a warning method according to yet another embodiment of the disclosure.

FIG. 8 is a flowchart of a warning method according to still another embodiment of the disclosure.

FIG. 9 is a flowchart of another warning method according to another embodiment of the disclosure.

FIG. 10 is a composition structure diagram of a warning apparatus according to an embodiment of the disclosure.

FIG. 11 is a schematic diagram of hardware entities of a warning device according to an embodiment of the disclosure.

### DETAILED DESCRIPTION

The technical solutions of the disclosure will be specifically described below in detail through the embodiments and in combination with the drawings. The following specific embodiments may be combined. The same or similar concepts or processes will not be repeated in some embodiments.

It is to be noted that, in the embodiments of the disclosure, “first”, “second” and the like are adopted to distinguish similar objects and not intended to describe a sequence or order of objectives. In addition, the technical solutions recorded in the embodiments of the disclosure may be freely combined without conflicts.

In the embodiments of the disclosure, “at least one” and “at least one frame” may refer to one or at least two and one frame or at least two frames respectively. In the embodiments of the disclosure, “multiple” and “multiple frames” may refer to at least two and at least two frames respectively. In the embodiments of the disclosure, at least one frame of image B shot after at least one frame of image A may refer to that the at least one frame of image B is adjacent to the at least one frame of image A, or, may refer to that the at least one frame of image B is spaced from the at least one frame of image A by one or more frames of images. Image A or image B may refer to any image in the embodiments of the disclosure. Enumerations thereof are omitted in the embodiments of the disclosure.

In the embodiments of the disclosure, at least one frame of image C may be images C shot continuously, or, may be images C shot discontinuously. The number of images C may be determined based on an actual situation, and no limits are made thereto in the embodiments of the disclosure. The image C may refer to any image in the embodiments of the disclosure.

The warning method provided in the embodiments of the disclosure may be applied to a casino scenario. In the casino scenario, the gamer mentioned anywhere in the embodiments of the disclosure may include a player or a banker, the game controller mentioned anywhere in the embodiments of the disclosure may refer to a dealer, the game table mentioned anywhere in the embodiments of the disclosure may refer to a gambling table, the token mentioned anywhere in the embodiments of the disclosure may include a chip, the placement region mentioned anywhere in the embodiments of the disclosure may refer to an anteing region or a betting region on the game table, and the management system mentioned anywhere in the embodiments of the disclosure may refer to a Casinos Management System (CMS).

In some implementation modes, the game at the game table may be Baccarat. In some other implementation modes, the game at the game table may be other games, such as Fishing Joy, Texas Poker, one-arm bandit, or show-hand. The game type is not limited in the embodiments of the disclosure. The game at the game table may be a card game or a non-card game.

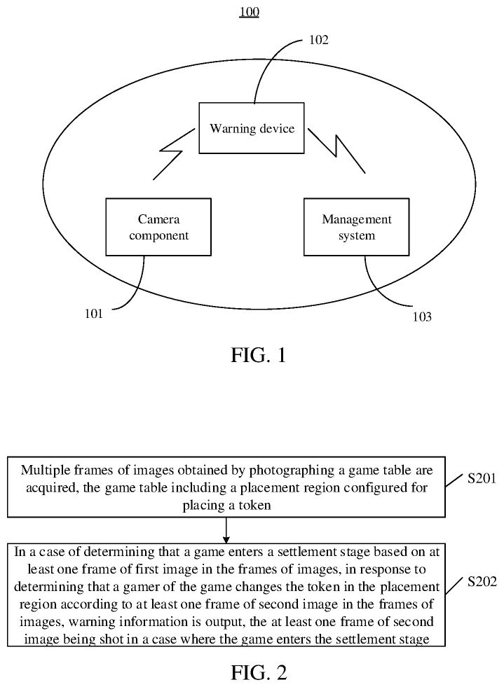

FIG. 1 is a structure diagram of a warning system according to an embodiment of the disclosure. As shown in FIG. 1, the warning system 100 may include a camera component 101, a warning device 102, and a management system 103.

In some implementation modes, the camera component 101 may include multiple cameras, and the cameras may photograph a game table from different angles. For example, the camera component 101 may include three cameras. A first camera may be an aerial view camera, and the first camera may be set up at the top of the game table. A second camera and a third camera are respectively set up at a side of the game table, and an included angle between the second camera and the third camera is a set included angle. For example, the set included angle may be 30 degrees to 120 degrees, and the set included angle may be 30 degrees, 60 degrees, 90 degrees, or 120 degrees. The second camera and the third camera may be arranged on the game table to photograph the situation of tokens on the game table and gamers from side views.

In some implementation modes, the warning device 102 may correspond to only one camera component 101. In some other implementation modes, the warning device 102 may correspond to multiple camera components 101. For example, the camera components 101 corresponding to the warning device 102 may be camera components 101 configured to photograph game tables in one or more game places, or, the camera components 101 corresponding to the warning device 102 may be camera components 101 configured to photograph game tables in a partial region of a game place. The partial region may be a common region, a Very Important Person (VIP) region, etc.

In some implementation modes, the warning device 102 may be arranged in a game place. For example, the warning device 102 may be connected with a server in the game place. In some other implementation modes, the warning device 102 may be arranged in a cloud.

The camera component 101 may be in communication connection with the warning device 102. In some implementation modes, the camera component 101 may shoot real-time images periodically or aperiodically, and send the shot real-time images to the warning device 102. For example, in a case where the camera component 101 includes multiple cameras, the cameras may shoot real-time images at an interval of a target time length, and send the shot real-time images to the warning device 102. The multiple cameras may shoot real-time images at the same time or at different time. In some other implementation modes, the camera component 101 may shoot a real-time video, and send the real-time video to the warning device 102. For example, in a case where the camera component 101 includes multiple cameras, the cameras may send shot real-time videos to the warning device 102 respectively such that the warning 102 extracts real-time images from the real-time videos. The real-time image in the embodiments of the disclosure may be any one or more of the following images.

In some implementation modes, the camera component may constantly shoot images, so as to constantly send the shot images to the warning device 102. In some other implementation modes, the camera component may be triggered by an objective to shoot an image. For example, the camera component may start shooting an image in response to an instruction that a game result comes out or a token is placed.

The warning device 102 may analyze the token on the game table and a game controller and gamer at the game table in the game place based on the real-time image to determine whether actions of the game controller and/or the gamer conform to rules or are proper.

The warning device 102 may be in communication connection with the management system 103. In a case where the warning device 102 determines that an action of the game controller or the gamer are improper, in order to reduce the loss of the game place or gamers, the warning device 102 may send warning information to the management system 103 on the game table corresponding to the game controller or gamer of the improper action, such that the management system 103 gives a warning corresponding to the warning information to warn the game controller or the gamer through the game table, to give an early warning about the situation that the improper action of the game controller or the gamer causes loss to the game place or gamers to timely correct the action or take other measures.

The embodiments of the disclosure are not limited thereto. In the embodiment corresponding to FIG. 1, the camera component 101, warning device 102 and management system 103 that are presented are independent respectively. However, in other embodiments, the camera component 101 and the warning device 102 may be integrated, or, the alarming device 102 and the management system 103 may be integrated.

A warning method provided in the embodiments of the disclosure will be described below. According to the method, actions of a gamer may be detected in a settlement stage of a game, and in a case where the gamer does an action that impairs the fairness in the game in the settlement stage of the game, the gamer may be warned through the warning system, thereby timely giving an early warning about the situation that the gamer does an action that does not conform to a game rule to cause loss t a game place.

FIG. 2 is a flowchart of a warning method according to an embodiment of the disclosure. As shown in FIG. 2, the method is applied to a warning device. The method includes the following operations.

In S201, multiple frames of images obtained by photographing a game table are acquired, the game table including a placement region configured for placing a token.

In some embodiments, the warning device may include an edge device, an edge terminal device, or an edge node. The warning device may be in communication connection with a server in a game place, so that the server may correspondingly control the warning device, and the warning device may also use services provided by the server. In some implementation modes, one warning device may be in one-to-one correspondence to one game table. In some other implementation modes, one warning device may correspond to multiple game tables.

In some implementation modes, a camera component may be arranged on the warning device, so that the game table may be photographed through the camera component to obtain multiple frames of images. In some other implementation modes, the camera component and the warning device are arranged separately, and the camera component may photograph the game table and send shot real-time images to the warning device such that the warning device determines multiple frames of images based on the real-time images. In some other implementation modes, the camera component on the warning device may shoot a video of the game table and extract multiple frames of images from the shot video. In some other implementation modes, the camera component may shoot a video of the game table and send the shot video to the warning device, so that the warning device may extract images from the received video and further obtain multiple frames of images based on the extracted images.

In a case where the camera component includes one camera, images shot continuously by the camera may be multiple frames of images, or, images extracted from a video shot by the camera are multiple frames of images. In a case where the camera component includes multiple cameras, multiple channels of images shot by the cameras are taken as multiple frames of images.

A round of game process may include a token placement stage, a game prop operating stage, and a settlement stage. In the token placement stage, a gamer may select a placement region representative of a certain party, and place a token therein. In the game prop operating stage, a game controller may operate a game prop on the game table to obtain a game result. After a game result of a game comes out, the warning device may determine, based on the game result, that each placement region is a placement region of a gamer that wins or a placement region of a gamer that loses. After the game result comes out, the settlement stage of the game is entered. In the settlement stage, the gamer is not allowed to change the token in any placement region on the game table, and the game controller may collect the token in the placement region of the loser, and deliver the token to the placement region of the winner. The placement region of the winner may represent that the gamer that places a token in the placement region wins, and the placement region of the loser may represent that the gamer that places a token in the placement region loses.

Taking a card game as an example, after a round of game starts, gamers may place tokens in one or more placement regions of placement regions on a game table, and a game controller may deal cards to each gamer at the game table. After the cards are dealt, the gamers may show their own card faces, the warning device may determine a game result based on the shot card face to determine a settlement operation that the game controller should execute based on the game result, and the game controller may determine which gamer wins and which gamer loses based on the card faces of the gamers. After the game result comes out, the settlement stage is entered, and the game controller may collect the token placed by the loser, and deliver the token to the winner. It is to be noted that, in the settlement stage, the gamer is not allowed to do an action of changing the token in the placement region on the game table.

In the embodiment of the disclosure, the frames of images may refer to images obtained by photographing the game table in a round of game or in a game.

In S202, in a case of determining, based on at least one frame of first image in the frames of images, that a game enters a settlement stage, in response to determining, according to at least one frame of second image in the frames of images, that the token in the placement region is changed by a gamer of the game, warning information is output, the at least one frame of second image being shot in a case where the game enters the settlement stage.

After a round of game starts, the token placement stage is entered, and the gamer may place a token in one or more placement regions on the game table in the token placement stage. After the token is placed, the game prop operating stage is entered, and the game controller may operate a game prop to obtain a game result in the game prop operating stage. After the game result comes out, the settlement stage is entered. In some implementation modes, in the game prop operating stage, the gamer may continue to place a token in the placement region where the token has been placed.

The at least one frame of first image may be shot in the game prop operating stage. In some implementation modes, a game result may be determined based on the at least one frame of first image, and the settlement stage is determined to be entered based on the game result.

The at least one frame of second image may be shot in the settlement stage. That the gamer changes the token in the placement region may include at least one of the following: the gamer adds a token to the placement region of the winner, the gamer takes a token away from the placement region of the loser, or the gamer adds a token to the placement region of the winner after the token in the placement region is cleared. That the gamer takes the token away from the placement region of the loser may include that: the gamer takes all or part of the token from the placement region of the loser.

In some implementation modes, the change of a scenario on the game table may be determined continuously or in real time according to a sequence of collecting images, an image collected before it is detected that a game result of the game table comes out is determined as the first image, and an image collected after it is detected that the game result of the game table comes out is determined as the second image.

In the embodiments of the disclosure, if not specified, the mentioned placement region may be any one or more placement regions on the game table, the mentioned game controller may be a person or a machine, and the mentioned gamer may be any one or more gamers at the game table.

In some implementation modes, the warning device may include a display, and the operation that the warning device outputs the warning information may include that: an outputting unit of the warning device outputs the warning information to the display such that the display of the warning device displays the warning information. In some other implementation modes, the operation that the warning device outputs the warning information may include that: the warning device outputs the warning information to an electronic device such that the electronic device displays the warning information. The electronic device may include a management system.

In some implementation modes, the gamer usually changes the token in the placement region by hands. At the game table, a position of the game controller is different from a position of the gamer (for example, at two opposite sides of the token placement region respectively), so that the warning device may determine, based on a hand action in a first preset direction and a change of the token in each placement region on the game table, that the gamer changes the token in the placement region. In some other implementation modes, a person associated with a hand appearing in each placement region may be identified to judge whether the person that operates the token in the placement region is the gamer or the game controller, and if the person is the gamer, it is determined that the token in the placement region is operated by the gamer in a game process.

In the embodiments of the disclosure, the warning information is output in a case of determining, based on the frames of images obtained by photographing the game table, that the gamer changes the token in the placement region in the settlement stage of the game, such that actions of the gamer are detected in a game process, and the gamer is prompted through the warning information to undo the action of changing the token in the settlement stage of the game. Therefore, the situation that actions, not conforming to a game rule, of the gamer cause loss to a game place is reduced.

FIG. 3 is a flowchart of another warning method according to an embodiment of the disclosure. As shown in FIG. 3, the method is applied to a warning device. In the embodiment of the disclosure, a game table includes a game prop operating region. The method includes the following operations.

In S301, multiple frames of images obtained by photographing the game table are acquired, the game table including a placement region configured for placing a token.

In some implementation modes, S301 may be implemented in the following manner: the frames of images obtained by photographing the game table are received from at least one camera set up at a side and/or top of the game table respectively. In some other implementation modes, S301 may be implemented in the following manner: at least one channel of video obtained by photographing the game table is received from the at least one camera set up at a side and/or top of the game table respectively; and the frames of images are extracted from the at least one channel of video.

In this manner, the acquired images or video are sent to the warning device through the camera, and then the warning device may obtain the frames of images, and may further detect an action of a gamer at the game table in real time, so that detection of the action of the gamer in a game process is implemented.

In S302, at least one frame of first image obtained by photographing the game table in a game prop operating stage of a game is acquired.

In S303, game prop information in the game prop operating region is determined based on the at least one frame of first image.

The game prop information may be information presented by a game prop. For example, if the game played on the game table is a card game, the game prop is cards, and the warning device may determine, based on the at least one frame of first image, that the game prop information is card face and/or suit information of dealt cards.

In S304, it is determined that the game enters a settlement stage according to the game prop information.

In some implementation modes, the warning device may determine a game result according to the game prop information, and determine that the game enters the settlement stage based on the game result.

In a case where the game is a card game, a game controller may continuously show dealt cards in the game prop operating stage, so that the warning device may continuously acquire card face and/or suit information of the shown cards. After the warning device acquires the card face and/or suit information of all the cards dealt by the game controller, the warning device may determine a game result based on the card face and/or suit information of all the dealt cards.

In S305, warning information is output in response to determining, according to at least one frame of second image in the multiple frames of images, that a gamer of the game changes the token in the placement region, the at least one frame of second image being shot in a case where the game enters the settlement stage.

The game prop operating stage may be a stage where the game controller operates the game prop.

In some implementation modes, the at least one frame of first image may be shot by the camera set up at the top, so that the game prop information in the game prop operating region may be photographed accurately through the camera at the top. In some implementation modes, the at least one frame of second image, and the following at least one frame of third image and at least one frame of fourth image may be shot by the camera set up at the side, so that the amount and/or total value of tokens in each placement region and an operator associated with changed token may be photographed accurately through the camera at the side. In some other implementation modes, the at least one frame of second image, and the following at least one frame of third image and at least one frame of fourth image may be shot by the cameras set up at the side and the top, so that the value of a token at the top of each pile of tokens in each placement region and the operator associated with the changed token may be photographed accurately through the camera at the top, the amount of each pile of tokens in each placement changes region and the operator associated with the changed token may be photographed accurately through the camera at the side, and then the warning device may obtain the amount and/or total value of the tokens in each placement region and the operator associated with the token accurately.

In some implementation modes, the operation that the warning information is output may include that: the warning information is output to a management system. The management system may give a warning corresponding to the warning information when receiving the warning information.

The management system may be an apparatus arranged on the game table for warning.

In some implementation modes, the management system may be a display apparatus arranged on the game table, and the display device may give a warning corresponding to the warning information after receiving the warning information. For example, the management system may give the warning corresponding to the warning information in a manner of displaying the warning information. In an implementation process, the management system may also generate at least one warning indication such as warning vibration, warning light, and a warning tone.

In some other implementation modes, the management system may include a control apparatus and a sub-apparatus corresponding to each placement region on the game table, and each sub-apparatus may include at least one of a display apparatus, a sound production apparatus, a light emitting apparatus, or a vibration apparatus.

In an implementation process, the warning information may include or indicate an identifier of one or more placement regions or action information, not conforming to a game rule, of the gamer, so that the control apparatus in the management system, when receiving the warning information, may control the sub-apparatus corresponding to one or more placement regions to work based on the identifier of the one or more placement regions and the action information, not conforming to the game rule, of the gamer. The operation that the sub-apparatus corresponding to one or more placement regions is controlled to work may include at least one of the following: the display apparatus corresponding to one or more placement regions is controlled to display action information, not conforming to the game rule, of the game controller and the gamer and/or a warning reason; the sound production apparatus corresponding to one or more placement regions is controlled to produce the warning tone, and/or the action information, not conforming to the game rule, of the game controller and the gamer, and/or the warning reason; and the light emitting apparatus corresponding to one or more placement regions is controlled to emit warning light, and the vibration apparatus corresponding to one or more placement regions is controlled to generate warning vibration. In some implementation modes, in a case of different action information, not conforming to the game rule, of the gamer, warning tones may be different, or, warning light may be different in at least one of color, brightness and flickering period, or vibration frequencies of warning vibration may be different. The warning reason may be determined based on the action information, not conforming to the game rule, of the gamer.

In some implementation modes, the action information, not conforming to the game rule, of the gamer may include at least one of: adding a token to a placement region of a winner; taking a token away from a placement region of a loser; or adding a token to the placement region of the winner after the token in the placement region is cleared.

In this manner, since the warning device may output the warning information to the management system in a case of determining that the gamer does an action that does not conform to the game rule, the management system may give a corresponding warning, and furthermore, the gamer may undo an actual settlement action inconsistent with a settlement action that should be executed based on the warning given by the management system. Therefore, the situation that incorrect actions of the gamer cause the loss to a game place is reduced.

In the embodiment of the disclosure, the game prop information in the game prop operating region may be determined based on at least one frame of first image obtained by shooting the game table in the game prop operating stage, and furthermore, the game result is generated based on the game prop information in the game prop operating region, so that the warning device may determine whether the gamer changes the token in the placement region based on the game result to implement detection of whether the action of the gamer during gaming conforms to the rule.

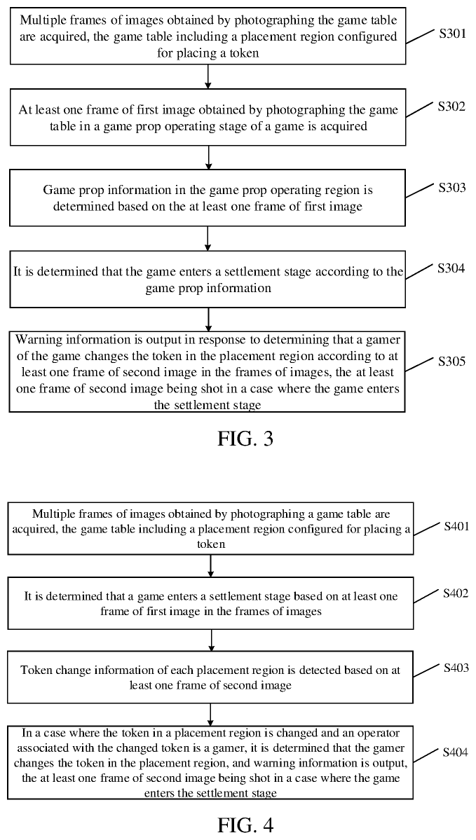

FIG. 4 is a flowchart of yet another warning method according to an embodiment of the disclosure. As shown in FIG. 4, the method is applied to a warning device. The method includes the following operations.

In S401, multiple frames of images obtained by photographing a game table are acquired, the game table including a placement region configured for placing a token.

In S402, it is determined that a game enters a settlement stage based on at least one frame of first image in the frames of images.

In S403, token change information of each placement region is detected based on at least one frame of second image.

The token change information may include one of increase in the amount of tokens, decrease in the amount of tokens, increase in a total value of tokens, or decrease in the total value of tokens. The decrease in the amount of tokens in a certain placement region or decrease in a total value of tokens may include clearing the token in the placement region.

In S404, in a case where the token in a placement region is changed and an operator associated with the changed token is a gamer, it is determined that the gamer changes the token in the placement region, and warning information is output, the at least one frame of second image being shot in a case where the game enters the settlement stage.

In the embodiment of the disclosure, at least one placement region configured for placing a token on the game table may include a first placement region and a second placement region, the first placement region may be one or more regions, the second placement region may be one or more regions, and the placement region corresponding to the first placement region does not overlap the placement region corresponding to the second placement region. A game result includes a win-lose judgment result between a gamer corresponding to the first placement region and a gamer corresponding to the second placement region.

In some implementation modes, in a case where the first placement region is a placement region of the loser and the second placement region is a placement region of the winner, the gamer may perform an operation of taking a token away from the placement region of the loser in the settlement stage of the game, to reduce the loss. In a case of determining that token change information of any first placement region is decrease in the amount and/or total value of tokens and an operator associated with the changed token is the gamer, the warning device determines that the gamer takes the token away from the any first placement region. In addition, the gamer may perform an operation of adding a token to the placement region of the winner, to increase the amount of token delivered by a game controller. In a case of determining that token change information of any second placement region is increase in the amount and/or total value of tokens and an operator associated with the changed token is the gamer, the warning device determines that the gamer adds the token to the any second placement region.

In some implementation modes, the at least one frame of second image may include a first subimage, a second subimage, and a third subimage.

The operation that the token change information of each placement region is detected based on the at least one frame of second image may include that: an attribute value of a first token in the placement region is determined based on the first subimage in the at least one frame of second image; the second subimage shot after the first subimage is acquired from the at least one frame of second image; the third subimage shot after the second subimage is acquired from the at least one frame of second image in a case of determining that an operator associated with the token in the placement region in the second subimage is the gamer; and an attribute value of a second token in the placement region in the third subimage is determined.

It is to be noted that the attribute value mentioned in any embodiment of the disclosure may include the amount and/or the total value. For example, an attribute value of tokens in a certain placement region may include the amount and/or total value of the tokens in the placement region. For example, there are two piles of tokens in a certain placement region, the amounts of the two piles of tokens are 5 and 10 respectively, total values of the two piles of tokens are 100 and 300 respectively, the total amount of the tokens in the placement region is 15, and a total value of the tokens in the placement region is 400.

The operation that it is determined that the gamer changes the token in the placement region in a case where the token in the placement region is changed and the operator associated with the changed token is the gamer may include that: in a case where the attribute value of the first token is different from the attribute value of the second token and the operator associated with the token in the placement region is the gamer, it is determined that the gamer changes the token in the placement region.

It is to be noted that any subimage in the first to twelfth subimages mentioned in the embodiment of the disclosure may include one frame of image, or, may include multiple frames of images. In a case where a certain frame of subimage includes multiple frames of images, an attribute value of a token in a specified placement region in the frame of subimage may be an attribute value of the token in the specified placement region in any image in the multiple frames of images, or, may be an attribute value of the token in the specified placement region in each image, attribute values of tokens in the specified placement region in the frames of images being the same.

In some implementation modes, object change information of each placement region in the second image may be detected continuously or in real time according to a sequence of collecting the second image. For one or more placement regions, an image that is collected before a token change is detected and includes no hands is determined as the first subimage, an image where a hand is detected is determined as the second subimage, and an image collected after the token change is detected is determined as the third subimage. The first subimage, the second subimage, and the third subimage may be images that are continuously collected.

In some implementation modes, in several placement regions where tokens are placed, if an attribute value of a first token in a specified placement region is less than an attribute value of a second token, it is determined that the amount of tokens in the specified placement region increases, and in a case where an operator associated with increase in the amount of the tokens is the gamer, it is determined that the gamer places a token in the specified placement region. The attribute value of the first token may be 0. And/or, if the attribute value of the first token in the specified placement region is greater than the attribute value of the second token, it is determined that the amount of the tokens in the specified placement region decreases, and in a case where an operator associated with decrease in the amount of the tokens is the gamer, it is further determined that the gamer takes a token away from the specified placement region. The attribute value of the second token may be 0.

In this manner, in a case where it may be determined, based on the first subimage, the second subimage and the third subimage, that an operator associated with the token in any placement region on the game table is the gamer and the token in the placement region is changed, it may be determined that the gamer changes the token in the placement region, and warning information is output to give a prompt about an incorrect action of the gamer, such that the gamer may undo the action of changing the token in the placement region based on the prompt given through the warning information. Therefore, the situation that actions, not conforming to a game rule, of the gamer cause the loss to a game place is reduced.

In some other implementation modes, the at least one frame of second image may include a seventh subimage, an eighth subimage, and a ninth subimage.

The operation that the token change information of each placement region is detected based on the at least one frame of second image may include that: the eighth subimage shot after the seventh subimage is acquired from the at least one frame of second image in a case of determining, based on the seventh subimage in the at least one frame of second image, that the token in the placement region in the seventh subimage is cleared; the ninth subimage shot after the second subimage is acquired from the at least one frame of second image in a case of determining that an operator associated with the token in the placement region in the eighth subimage is the gamer; and in a case where there is token in the placement region in the ninth subimage, it is determined that the token change information of the placement region includes addition of a new token after the token is cleared.

The operation that it is determined that the gamer changes the token in the placement region in a case where the token in the placement region is changed and the operator associated with the changed token is the gamer may include that: in a case of determining that a new token is added after the token in the placement region is cleared and the operator associated with the token in the placement region is the gamer, it is determined that the gamer changes the token in the placement region.

In some implementation modes, the object change information of each placement region in the second image may be detected continuously or in real time according to the sequence of collecting the second image. For one or more placement regions, an image where it is detected that the token is cleared is determined as the seventh subimage, an image where a hand is detected is determined as the eighth subimage, and an image where the token in the placement region is detected is determined as the ninth subimage. The seventh subimage, the eighth subimage and the ninth subimage may be images that are continuously collected.

In some other implementation modes, since the game controller usually does not add a token to the placement region where the token is cleared and that corresponds to a certain winner in the settlement stage of the game, if the warning device determines that a certain set region is a placement region of a winner and determines that, in the settlement stage of the game, there is a new token after the token in the placement region of the winner is cleared, it is directly determined that the gamer adds the token to the placement region of the winner without determining whether an operator associated with such a token change is the gamer or the game controller.

In this manner, in a case of determining, based on the seventh subimage, the eighth subimage, and the ninth subimage, that a new token is added after the token in the placement region is cleared and the operator associated with addition after clearing the token is the gamer, warning information may be output to give a prompt about the incorrect action of the gamer, such that the gamer may undo the action of changing the token in the placement region based on the prompt given through the warning information. Therefore, the situation that actions, not conforming to the game rule, of the gamer cause the loss to the game place is reduced.

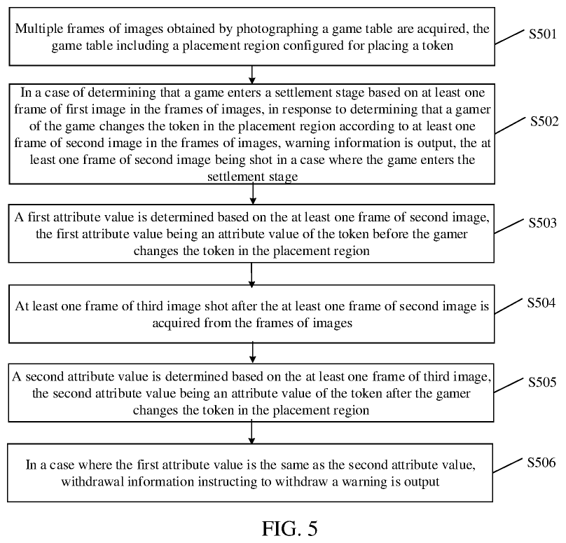

FIG. 5 is a flowchart of still another warning method according to an embodiment of the disclosure. As shown in FIG. 5, the method is applied to a warning device. The method includes the following operations.

In S501, multiple frames of images obtained by photographing a game table are acquired, the game table including a placement region configured for placing a token.

In S502, in a case of determining that a game enters a settlement stage based on at least one frame of first image in the frames of images, in response to determining that a gamer of the game changes the token in the placement region according to at least one frame of second image in the frames of images, warning information is output, the at least one frame of second image being shot in a case where the game enters the settlement stage.

In S503, a first attribute value is determined based on the at least one frame of second image, the first attribute value being an attribute value of the token before the gamer changes the token in the placement region.

In S504, at least one frame of third image shot after the at least one frame of second image is acquired from the frames of images.

In S505, a second attribute value is determined based on the at least one frame of third image, the second attribute value being an attribute value of the token after the gamer changes the token in the placement region.

In some implementation modes, the change of a scenario on the game table may be collected continuously or in real time according to a sequence of collecting images, an image where it is detected that the gamer changes the token in the placement region and an image shot before the image are determined as second images, and an image shot after it is detected that the changes gamer changes the token in the placement region is determined as a third image.

In S506, in a case where the first attribute value is the same as the second attribute value, withdrawal information instructing to withdraw a warning is output.

For example, in a case where the warning device determines that the gamer adds a token to a certain placement region, if it is determined, based on the at least one frame of third image, that an attribute value of the token is recovered to an attribute value of the token in the placement region before the gamer adds the token to the placement region, it is determined that the gamer undoes the action of adding the token to the placement region, and withdrawal information is output.

For another example, in a case where the warning device determines that the gamer takes a token away from a certain placement region, if it is determined, based on the at least one frame of third image, that an attribute value of the token is recovered to an attribute value of the token in the placement region before the gamer takes the token away from the placement region, it is determined that the gamer undoes the action of taking the token away from the placement region, and withdrawal information is output.

In some implementation modes, the operation that the withdrawal information instructing to withdraw the warning is output may include that: the withdrawal information instructing to withdraw the warning is output to a management system. Then, the management system stops or withdraws a present warning corresponding to the warning information when receiving the withdrawal information.

In some implementation modes, in a case where a display apparatus displays action information, not conforming to a game rule, of the gamer and/or a warning reason, the display apparatus may stop displaying or not display the action information, not conforming to the game rule, of the gamer and/or the warning reason based on the withdrawal information. In some other implementation modes, in a case where a sound production apparatus produces a warning tone and/or the warning reason, the sound production apparatus may stop producing the warning tone and/or the warning reason based on the withdrawal information. In some other implementation modes, in a case where a light emitting apparatus emits warning light, the light emitting apparatus may stop emitting the warning light based on the withdrawal information. In some other implementation modes, in a case where a vibration apparatus generates warning vibration, the vibration apparatus may stop generating warning vibration based on the withdrawal information.

Some implementation scenarios of outputting the withdrawal information will be described below.

In some implementation scenarios, in a case where the warning device determines that a first gamer adds a token to a placement region of one or more winners, warning information is output to the management system, and the management system may display a warning on the display apparatus, or, the management system may warn through a sub-apparatus corresponding to the placement region of the one or more winners. Afterwards, in a case where the warning device determines that the first gamer reclaims the token added to the placement region of the one or more winners, withdrawal information is output to the management system to stop warning of the management system.

In some other implementation scenarios, in a case where the warning device determines that a second gamer takes token away from a placement region of one or more losers, warning information is output to the management system, and the management system may display a warning on the display apparatus, or, the management system may warn through a sub-apparatus corresponding to the placement region of the one or more losers. Afterwards, in a case where the warning device determines that the second gamer places the token that is taken away back to the placement region of the one or more losers, withdrawal information is output to the management system to stop warning of the management system.

In some further other implementation scenarios, in a case where the warning device determines that a third gamer adds a token to a placement region of one or more winners after the token in the placement region of the one or more winners is cleared, warning information is output to the management system, and the management system may display a warning on the display apparatus, or, the management system may warn through a sub-apparatus corresponding to the placement region of the one or more winners. Afterwards, in a case where the warning device determines that the third gamer clears the token in the placement region of the one or more winners, withdrawal information is output to the management system to stop warning of the management system.

In the embodiment of the disclosure, after the warning information indicating the warning is output, the withdrawal information instructing to withdraw the warning may further be output in a case of determining, based on the at least one frame of third image shot continuously, that the gamer undoes the action of adding the token to the placement region or undoes the action of taking the token away from the placement region, so that warning is stopped based on the withdrawal information to continue the game.

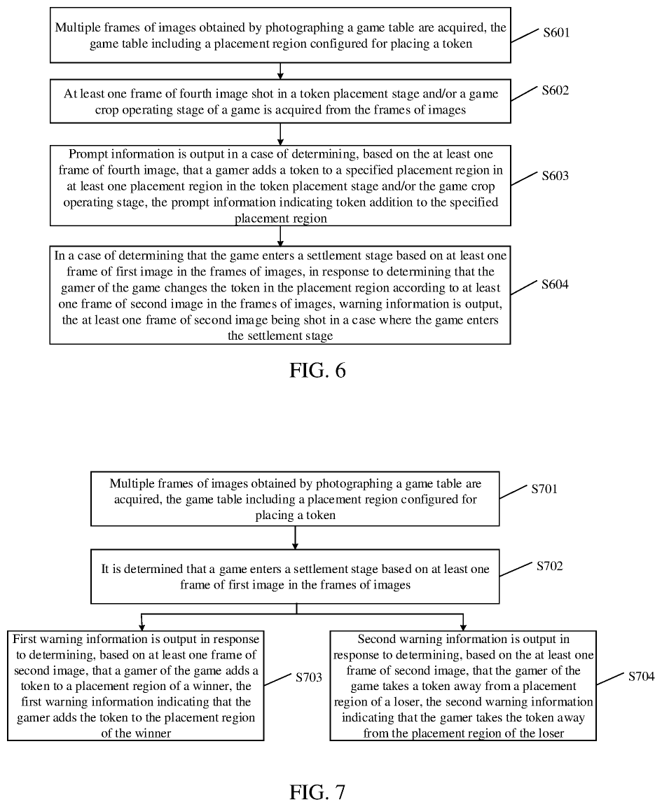

FIG. 6 is a flowchart of a warning method according to another embodiment of the disclosure. As shown in FIG. 6, the method is applied to a warning device. The method includes the following operations.

In S601, multiple frames of images obtained by photographing a game table are acquired, the game table including a placement region configured for placing a token.

In S602, at least one frame of fourth image shot in a token placement stage and/or a game crop operating stage of a game is acquired from the frames of images.

In S603, prompt information is output in a case of determining, based on the at least one frame of fourth image, that a gamer adds a token to a specified placement region in at least one placement region in the token placement stage and/or the game crop operating stage, the prompt information indicating token addition to the specified placement region.

A manner in which the warning device determines a first image, a second image, a third image and a fourth image in images shot continuously in a round of game in an implementation process of the disclosure will be described below.

A round of game may include a token placement stage, a game prop operating stage, and a settlement stage in turn.

In the token placement stage, the gamer places a token in the placement region configured for placing a token on the game table. After the token is placed, the game prop operating stage is entered. In some implementation modes, in the game prop operating stage, the gamer may also continue adding a token to the placement region where the token has been placed. After a game result comes out, the gamer may change the token in the placement region.

In the game prop operating stage, a game controller may operate a game prop in a game prop operating region to obtain the game result. After the game result comes out, the settlement stage is entered.

In a round of game, an image shot in the token placement stage may be determined as at least one frame of fourth image, and an image shot in the game prop operating stage may be determined as at least one frame of first image. In the settlement stage, an image configured for determining that the gamer changes the token in the placement region and an image shot before the image are determined as at least one frame of second image, and an image shot after the at least one frame of second image and configured for determining that the gamer undoes the action of changing the token in the placement region are determined as at least one frame of third image. In some other implementation modes, an image configured for determining the action that the gamer places a token in the placement region or adds a token to a region where a token has been placed is determined as at least one frame of fourth image, and an image that may be configured for determining the game result before the settlement stage is determined as at least one frame of first image.

The operation that the prompt information is output may include that: the prompt information is output to a management system. In some implementation modes, the management system may include a sub-apparatus corresponding to each placement region. In a case where the gamer adds the token to the specified placement region before the game result comes out, the sub-apparatus corresponding to the specified placement region may correspondingly perform displaying, sound production, light emission, vibration, etc. For example, the management system, after receiving the prompt information, may control the sub-apparatus corresponding to the specified placement region to vibrate based on the prompt information.

In S604, in a case of determining that the game enters a settlement stage based on at least one frame of first image in the frames of images, in response to determining that the gamer of the game changes the token in the placement region according to at least one frame of second image in the frames of images, warning information is output, the at least one frame of second image being shot in a case where the game enters the settlement stage.

In the embodiment of the disclosure, in a case where the gamer adds the token to the specified placement region, token addition to the specified placement region may be prompted through the at least one frame of fourth image shot when the gamer places the token, so that the sense of science and technology of the game is enhanced, and the gamer can be entertained better.

FIG. 7 is a flowchart of a warning method according to yet another embodiment of the disclosure. As shown in FIG. 7, the method is applied to a warning device. The method includes the following operations.

In S701, multiple frames of images obtained by photographing a game table are acquired, the game table including a placement region configured for placing a token.

In S702, it is determined that a game enters a settlement stage based on at least one frame of first image in the frames of images.

In S703, first warning information is output in response to determining, based on at least one frame of second image, that a gamer of the game adds a token to a placement region of a winner, the first warning information indicating that the gamer adds the token to the placement region of the winner.

In some implementation modes, the warning device may first acquire a first subimage and determine an attribute value of the token in a placement region of each winner in the first subimage. Then, a second subimage is acquired, and it is determined that a hand of the gamer appears in the placement region of a certain winner in the second subimage. Next, a third subimage is acquired, and in a case of determining that the attribute value of the token in the placement region of the winner in the third subimage is greater than the attribute value of the token in the placement region of the winner in the first subimage, it is determined that the gamer adds the token to the placement region of the winner.

The warning device may further acquire a tenth subimage shot after the at least one frame of second image. In such case, after outputting the first warning information, the warning device may output first withdrawal information in a case of determining, based on the tenth subimage, that the gamer takes the added token away from the placement region of the winner, the first withdrawal information instructing to withdraw a warning corresponding to the first warning information.

In S704, second warning information is output in response to determining, based on the at least one frame of second image, that the gamer of the game takes a token away from a placement region of a loser, the second warning information indicating that the gamer takes the token away from the placement region of the loser.

In some implementation modes, the warning device may first acquire a first subimage and determine an attribute value of the token in a placement region of each loser in the first subimage. Then, a second subimage is acquired, and it is determined that the hand of the gamer appears in the placement region of a certain loser in the second subimage. Next, a third subimage is acquired, and in a case of determining that an attribute value of the token in the placement region of the loser in the third subimage is less than the attribute value of the token in the placement region of the loser in the first subimage, it is determined that the gamer takes the token away from the placement region of the loser.

The warning device may further acquire an eleventh subimage shot after the second subimage. In such case, after outputting the second warning information, the warning device may output second withdrawal information in a case of determining, based on the eleventh subimage, that the token which has been taken away is returned to the placement region of the loser, the second withdrawal information instructing to withdraw a warning corresponding to the second warning information.

In some implementation modes, the operation that the first withdrawal information/second withdrawal information is output may include that: the first withdrawal information/second withdrawal information is output to a management system. In an implementation process, the first withdrawal information/second withdrawal information may include or indicate an identifier of the placement region corresponding to warning. In such case, in a case of receiving the first withdrawal information/second withdrawal information, the management system may stop warning in the placement region corresponding to the identifier of the placement region.

In the embodiment of the disclosure, the first warning information is output in a case of detecting that the gamer of the game adds the token to the placement region of the winner, and the second warning information is output in a case of detecting that the gamer of the game takes the token away from the placement region of the loser, so that a warning about an incorrect action, not conforming to a game rule, of the gamer may be given in the settlement stage of the game to reduce the loss caused by the incorrect action of the gamer to a game place.

In some embodiments, the warning method provided in the embodiment of the disclosure may further include the following steps. An attribute value of a third token in the placement region is determined based on a fourth subimage in the at least one frame of second image. A fifth subimage shot after the fourth subimage is acquired from the at least one frame of second image. A sixth subimage shot after the fifth subimage is acquired from the at least one frame of second image in a case of determining that an operator associated with the token in the placement region in the fifth subimage is the game controller. An attribute value of a fourth token in the placement region in the sixth subimage is determined. In a case where the attribute value of the third token is different from the attribute value of the fourth token, it is determined that the game controller changes the token in the placement region.

The fourth subimage and the first subimage may be the image the same or different. The fifth subimage and the second subimage may be the same or different. The sixth subimage and the third subimage may be the same or different.

In some implementation modes, the game controller may hold a token collection apparatus, the token collection apparatus may be a chip collection apparatus configured to collect chips placed by the gamer, the game controller may perform settlement on tokens on the game table through the token collection apparatus, and in a case of determining that the token collection apparatus exists in the placement region in the fifth subimage, the warning device determines that the operator associated with the token in the placement region in the fifth subimage is the game controller. In some other implementation modes, the warning device may determine that the game controller changes the token in each placement region based on a hand action in a second preset direction and a change of the token in each placement region on the game table. The first preset direction is opposite to the second preset direction, or, an angle between the first preset direction and the second preset direction is larger than a set angle. In some other implementation modes, a person associated with a hand appearing in each placement region may be identified to judge whether the person that operates the token in the placement region is the game controller to further determine an operation of the game controller over the token in each placement region.

In an implementation process, it is a normal action of the game controller in the game process that the game controller performs delivery for the token in the placement region of the winner to cause increase in the amount of the token in the placement region of the winner; and it is a normal action of the game controller in the game process that the game controller collects the token in the placement region of the loser to cause decrease in the amount of the token in the placement region of the loser. Therefore, the warning device may continue to detect the next frame of image, and does not output any warning information.

In this manner, the warning device also detects whether an operator associated with a change of the token in a certain placement region is the game controller, and does not output any warning information in a case of determining that the operator associated with the change of the token in the placement region is the game controller, so that actions of the gamer or actions of the game controller in the game process may be detected accurately to give a warning about gamer actions that do not conform to a game rule.

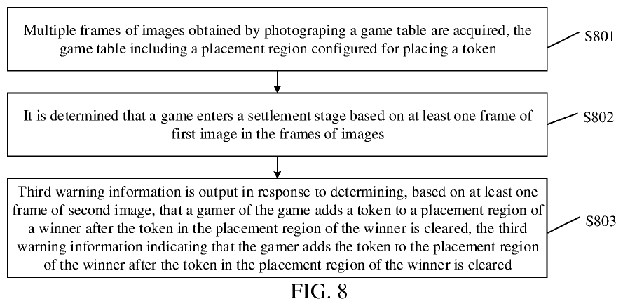

FIG. 8 is a flowchart of a warning method according to still another embodiment of the disclosure. As shown in FIG. 8, the method is applied to a warning device. The method includes the following operations.

In S801, multiple frames of images obtained by photographing a game table are acquired, the game table including a placement region configured for placing a token.

In S802, it is determined that a game enters a settlement stage based on at least one frame of first image in the frames of images.

In S803, third warning information is output in response to determining, based on at least one frame of second image, that a gamer of the game adds a token to a placement region of a winner after the token in the placement region of the winner is cleared, the third warning information indicating that the gamer adds the token to the placement region of the winner after the token in the placement region of the winner is cleared.

In some implementation modes, the operation that the third warning information is output may include that: the third warning information is output to a management system. The third warning information may also indicate an identifier of the placement region which has the token added by the gamer after clearance and corresponds to the winner. In a case of receiving the third warning information, the warning device may give a warning about addition after the token in the placement region is cleared through the identifier of the placement region.

In some implementation modes, the warning device may first acquire a seventh subimage and determine that the token in a placement region of a certain winner is cleared. Then, an eighth subimage is acquired, and it is determined that an operator associated with the token in the eighth subimage is the gamer. Next, in a case of determining, based on an acquired ninth subimage, that there is a token in the placement region of the winner in the ninth subimage, it is determined that the gamer adds the token after the token in the placement region of the winner is cleared.

The warning device may further acquire a twelfth subimage shot after the ninth subimage. In such case, after outputting the third warning information, the warning device may output third withdrawal information in a case of determining, based on the twelfth subimage, that the gamer clears the token in the placement region of the winner, the third withdrawal information instructing to withdraw a warning corresponding to the third warning information.

In some implementation modes, the operation that the third withdrawal information is output may include that: the third withdrawal information is output to a management system. In an implementation process, the third withdrawal information may include or indicate an identifier of the placement region corresponding to warning. In such case, in a case of receiving the third withdrawal information, the management system may stop warning in the placement region corresponding to the identifier of the placement region.

In the embodiment of the disclosure, the third warning information is output in response to detecting that the gamer of the game adds the token to the placement region of the winner after the token in the placement region of the winner is cleared, so that a warning about an incorrect action, not conforming to a game rule, of the gamer may be given in the settlement stage of the game to reduce the situation that the game controller performs secondary payment in the placement region of the winner without knowing the incorrect action of the gamer to cause the loss to a game place.

In the embodiment of the disclosure, the warning device is turned on, the gamer places a token in the placement region, and before the game result comes out, the warning device may analyze an acquired real-time image to determine that the amount of the token on the game table keeps increasing. After the game result on the game table comes out, the warning device may determine whether the token in each placement region is the token in the placement region of the winner or the token in the placement region of the loser based on the game result. Afterwards, the warning device may judge whether the gamer moves the token in the placement region based on token data (for example, the amount of the token and/or a total value of the token) in the at least one frame of second image, and if YES, the warning device generates a warning. For example, in a collection-payment stage, if the gamer adds a token to the placement region of the winner, or, if the gamer takes a token away from the placement region of the loser, or, if the gamer adds a token to the placement region of the winner after the token in the placement region of the winner is cleared, the warning device may output the warning information to the management system in a case of detecting these improper actions of the gamer, so that the management system may warn through a display apparatus, or, the management system may warn in the corresponding placement region through a sub-apparatus. If the gamer does not change the token in any placement region in the settlement stage of a round of game, no warning is generated.

In the embodiment of the disclosure, the operation that the warning device analyzes any image may include that: a parsing layer of the warning device analyzes any image.

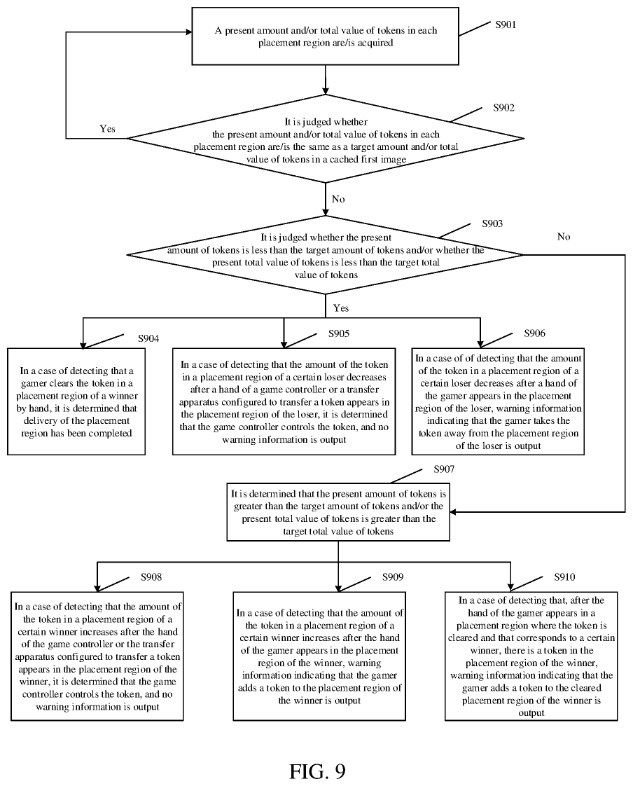

FIG. 9 is a flowchart of another warning method according to another embodiment of the disclosure. As shown in FIG. 9, the method is applied to a warning device. The method includes the following operations.

In S901, a present amount and/or total value of tokens in each placement region are/is acquired.

In S902, it is judged whether the present amount and/or total value of the tokens in each placement region are/is the same as a target amount and/or target total value of tokens in a cached first image.

The cached first image may be one frame of image or multiple frames of images. The first image may be an image which may be used for determining to start a settlement stage.

If YES, S901 is executed to continue to determine a present amount and/or total value of tokens based on a present frame of image that is subsequently collected. If NO, S903 is executed.

In S903, it is judged whether the present amount of tokens is less than the target amount of tokens and/or whether the present total value of tokens is less than the target total value of tokens.

If both are YES, any one or more of S904 to S906 may be executed. If both are NO, S907 is executed.

In S904, in a case of detecting that a gamer clears the token in a placement region of a winner by hand, it is determined that delivery of the placement region has been completed.

In S905, in a case of detecting that the amount of the token in a placement region of a certain loser decreases after a hand of a game controller or a transfer apparatus configured to transfer a token appears in the placement region of the loser, it is determined that the game controller controls the token, and no warning information is output.

In S906, in a case of detecting that the amount of the token in a placement region of a certain loser decreases after a hand of the gamer appears in the placement region of the loser, warning information indicating that the gamer takes the token away from the placement region of the loser is output.

In S907, it is determined that the present amount of tokens is greater than the target amount of tokens and/or the present total value of tokens is greater than the target total value of tokens.

After S907, any one or more of S908 to S910 may be executed.

In S908, in a case of detecting that the amount of the token in a placement region of a certain winner increases after the hand of the game controller or the transfer apparatus configured to transfer a token appears in the placement region of the winner, it is determined that the game controller controls the token, and no warning information is output.

In S909, in a case of detecting that the amount of the token in a placement region of a certain winner increases after the hand of the gamer appears in the placement region of the winner, warning information indicating that the gamer adds a token to the placement region of the winner is output.

In S910, in a case of detecting that, after the hand of the gamer appears in a placement region where the token is cleared and that corresponds to a certain winner, there is a token in the placement region of the winner, warning information indicating that the gamer adds a token to the cleared placement region of the winner is output.

Based on the abovementioned embodiments, the embodiments of the disclosure provide a warning apparatus. Various units and various modules therein may be implemented through a processor in the warning apparatus, and of course, may also be implemented through a specific logic circuit.

FIG. 10 is a composition structure diagram of a warning apparatus according to an embodiment of the disclosure. As shown in FIG. 10, the warning apparatus 1000 includes an acquisition unit 1001 and an outputting unit 1002.

The acquisition unit 1001 is configured to acquire multiple frames of images obtained by photographing the game table, the game table including a placement region configured for placing a token.

The outputting unit 1002 is configured to, in a case of determining that the game enters a settlement stage based on at least one frame of first image in the frames of images, in response to determining that the gamer of the game changes the token in the placement region according to at least one frame of second image in the frames of images, output warning information, the at least one frame of second image being shot in a case where the game enters the settlement stage.

In some embodiments, the warning apparatus 10001 further includes a determination unit 1003, which is configured to acquire the at least one frame of first image obtained by photographing the game table in a game prop operating stage of the game, determine game prop information in a game prop operating region based on the at least one frame of first image, and determine that the game enters the settlement stage according to the game prop information.

In some embodiments, the determination unit 1003 is further configured to detect token change information of each placement region based on the at least one frame of second image, and in a case where the token in the placement region is changed and an operator associated with the changed token is the gamer, determine that the gamer changes the token in the placement region.

In some implementation modes, the acquisition unit 1001 is further configured to receive the frames of images obtained by photographing the game table from at least one camera set up at a side and/or top of the game table respectively.

In some embodiments, the acquisition unit 1001 is further configured to receive at least one channel of video obtained by photographing the game table from the at least one camera set up at the side and/or top of the game table respectively, and extract the frames of images from the at least one channel of video.

In some embodiments, the outputting unit 1002 is further configured to output the warning information to a management system.

In some embodiments, the determination unit 1003 is further configured to determine a first attribute value based on the at least one frame of second image, the first attribute value being an attribute value of the token before the gamer changes the token in the placement region. The acquisition unit 1001 is further configured to acquire at least one frame of third image shot after the at least one frame of second image from the frames of images. The determination unit 1003 is further configured to determine a second attribute value based on the at least one frame of third image, the second attribute value being an attribute value of the token after the gamer changes the token in the placement region. The outputting unit 1002 is further configured to, in a case where the first attribute value is the same as the second attribute value, output withdrawal information instructing to withdraw a warning.

In some embodiments, the acquisition unit 1001 is further configured to acquire at least one frame of fourth image shot in a token placement stage and/or the game prop operating stage of the game from the frames of images. The determination unit 1003 is further configured to output prompt information in a case of determining, based on the at least one frame of fourth image, that the gamer adds a token to a specified placement region in at least one placement region in the token placement stage and/or the game prop operating stage, the prompt information indicating token addition to the specified placement region.

In some embodiments, the outputting unit 1002 is further configured to output first warning information in response to determining, based on the at least one frame of second image, that the gamer of the game adds a token to a placement region of a winner, the first warning information indicating the token addition of the gamer to the placement region of the winner.

In some embodiments, the outputting unit 1002 is further configured to output second warning information in response to determining, based on the at least one frame of second image, that the gamer of the game takes a token away from a placement region of a loser, the second warning information indicating token takeaway of the gamer from the placement region of the loser.

In some embodiments, the determination unit 1003 is further configured to determine an attribute value of a first token in the placement region based on a first subimage in the at least one frame of second image, acquire a second subimage shot after the first subimage from the at least one frame of second image, acquire a third subimage shot after the second subimage from the at least one frame of second image in a case of determining that an operator associated with the token in the placement region in the second subimage is the gamer, and determine an attribute value of a second token in the placement region in the third subimage.

The determination unit 1003 is further configured to, in a case where the attribute value of the first token is different from the attribute value of the second token and the operator associated with the token in the placement region is the gamer, determine that the gamer changes the token in the placement region.

In some embodiments, the determination unit 1003 is further configured to determine an attribute value of a third token in the placement region based on a fourth subimage in the at least one frame of second image. The acquisition unit 1001 is further configured to acquire a fifth subimage shot after the fourth subimage from the at least one frame of second image, and acquire a sixth subimage shot after the fifth subimage from the at least one frame of second image in a case of determining that an operator associated with the token in the placement region in the fifth subimage is a game controller. The determination unit 1003 is further configured to determine an attribute value of a fourth token in the placement region in the sixth subimage, and determine that the game controller changes the token in the placement region in a case where the attribute value of the third token is different from the attribute value of the fourth token.

In some embodiments, the outputting unit 1002 is further configured to output third warning information in response to determining, based on the at least one frame of second image, that the gamer of the game adds a token to the placement region of the winner after the token in the placement region of the winner is cleared, the third warning information indicating that the gamer adds the token to the placement region of the winner after the token in the placement region of the winner is cleared.

In some embodiments, the determination unit 1003 is further configured to acquire an eighth subimage shot after a seventh subimage from the at least one frame of second image in a case of determining, based on the seventh subimage in the at least one frame of second image, that the token in the placement region in the seventh subimage is cleared, acquire a ninth subimage shot after the eighth subimage from the at least one frame of second image in a case of determining that an operator associated with the token in the placement region in the eighth subimage is the gamer, and in a case where there is token in the placement region in the ninth subimage, determine that the token change information of the placement region includes addition of new token after the token is cleared.

In some embodiments, the determination unit 1003 is further configured to, in a case of determining that a new token is added after the token in the placement region is cleared and an operator associated with the token in the placement region is the gamer, determine that the gamer changes the token in the placement region.

The above descriptions about the apparatus embodiments are similar to descriptions about the method embodiments and beneficial effects similar to those of the method embodiments are achieved. Technical details undisclosed in the apparatus embodiments of the disclosure may be understood with reference to the descriptions about the method embodiments of the disclosure.

It is to be noted that, in the embodiments of the disclosure, when implemented in form of software function module and sold or used as an independent product, the warning method may also be stored in a computer-readable storage medium. Based on such an understanding, the technical solutions of the embodiments of the disclosure substantially or parts making contributions to the related art may be embodied in form of a software product. The computer software product is stored in a storage medium, including a plurality of instructions configured to enable a device to execute all or part of the method in each embodiment of the disclosure. The storage medium includes various media capable of storing program codes such as a U disk, a mobile hard disk, a Read Only Memory (ROM), a magnetic disk or an optical disk. Therefore, the embodiments of the disclosure are not limited to any target hardware and software combination.

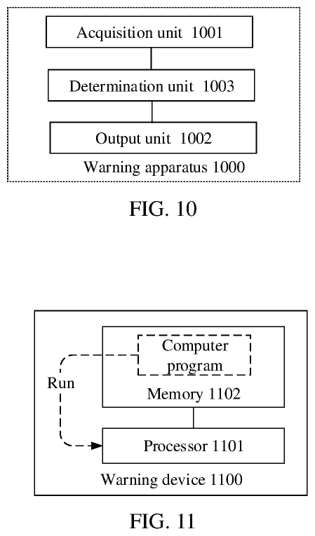

FIG. 11 is a schematic diagram of hardware entities of a warning device according to an embodiment of the disclosure. As shown in FIG. 11, the hardware entities of the warning device 1100 include a processor 1101 and a memory 1102. The memory 1102 stores a computer program capable of running in the processor 1101. The processor 1101 implements the steps in the method of any of the above embodiments when executing the program. In some implementation modes, the device 1100 that collects and pays tokens on a game table may be the warning device described in any of the above embodiments.

The memory 1102 stores the computer program capable of running in the processor 1101. The memory 1102 is configured to store an instruction and application executable by the processor 1101, may also cache data (for example, image data, audio data, voice communication data, and video communication data) to be processed or having been processed by the processor 1201 and each module in the warning device 1100, and may be implemented through a flash or a Random Access Memory (RAM).

The processor 1101 executes the program to implement the steps of any warning method described above. The processor 1101 usually controls overall operations of the warning device 1100.

The embodiments of the disclosure provide a computer storage medium, which stores one or more programs. The one or more programs may be executed by one or more processors to implement the steps of the warning method in any of the above embodiments.

It is to be pointed out here that the above descriptions about the storage medium and device embodiments are similar to the descriptions about the method embodiment and beneficial effects similar to those of the method embodiment are achieved. Technical details undisclosed in the storage medium and device embodiments of the disclosure are understood with reference to the descriptions about the method embodiment of the disclosure.

The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a controller, a microcontroller, or a microprocessor. It can be understood that other electronic devices may also be configured to realize functions of the processor, and no specific limits are made in the embodiments of the disclosure.

The computer storage medium/memory may be a memory such as a ROM, a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any terminal including one or any combination of the abovementioned memories, such as a mobile phone, a computer, a tablet device, and a personal digital assistant.

It is to be understood that “one embodiment” or “an embodiment” or “the embodiment of the disclosure” or “the abovementioned embodiment” or “some embodiments” mentioned in the whole specification means that target features, structures or characteristics related to the embodiment are included in at least one embodiment of the disclosure. Therefore, “in one embodiment” or “in an embodiment” or “the embodiment of the disclosure” or “the abovementioned embodiment” or “some embodiments” appearing everywhere in the whole specification does not always refer to the same embodiment. In addition, these target features, structures or characteristics may be combined in one or more embodiments freely as appropriate. It is to be understood that, in each embodiment of the disclosure, a magnitude of a sequence number of each process does not mean an execution sequence and the execution sequence of each process should be determined by its function and an internal logic and should not form any limit to an implementation process of the embodiments of the disclosure. The sequence numbers of the embodiments of the disclosure are adopted not to represent superiority-inferiority of the embodiments but only for description.

If not specified, when the warning device executes any step in the embodiments of the disclosure, the processor of the warning device executes the step. Unless otherwise specified, the sequence of execution of the following steps by the warning device is not limited in the embodiments of the disclosure. In addition, the same method or different methods may be used to process data in different embodiments. It is also to be noted that any step in the embodiments of the disclosure may be executed independently by the warning device, namely the warning device may execute any step in the abovementioned embodiments independent of execution of the other steps.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each function unit in each embodiment of the disclosure may be integrated into a processing unit, each unit may also serve as an independent unit and two or more than two units may also be integrated into a unit. The integrated unit may be implemented in a hardware form and may also be implemented in form of hardware and software function unit.

The methods disclosed in some method embodiments provided in the disclosure may be freely combined without conflicts to obtain new method embodiments.

The characteristics disclosed in some product embodiments provided in the disclosure may be freely combined without conflicts to obtain new product embodiments.

The characteristics disclosed in some method or device embodiments provided in the disclosure may be freely combined without conflicts to obtain new method embodiments or device embodiments.

Those of ordinary skill in the art should know that all or part of the steps of the method embodiment may be implemented by related hardware instructed through a program, the program may be stored in a computer-readable storage medium, and the program is executed to execute the steps of the method embodiment. The storage medium includes: various media capable of storing program codes such as a mobile storage device, a ROM, a magnetic disk, or an optical disc.

Or, when implemented in form of software function module and sold or used as an independent product, the integrated unit of the disclosure may also be stored in a computer-readable storage medium. Based on such an understanding, the technical solutions of the embodiments of the disclosure substantially or parts making contributions to the related art may be embodied in form of a software product. The computer software product is stored in a storage medium, including a plurality of instructions configured to cause a computer device (which may be a personal computer, a warning device, a network device or the like) to execute all or part of the method in each embodiment of the disclosure. The storage medium includes: various media capable of storing program codes such as a mobile hard disk, a ROM, a magnetic disk, or an optical disc.

In the embodiments of the disclosure, the descriptions about the same steps and the same contents in different embodiments may refer to those in the other embodiments. In the embodiments of the disclosure, term “and” does not influence the sequence of the steps.

The above is only the implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A warning method, comprising:
acquiring a plurality of frames of images obtained by photographing a game table, wherein the game table comprises a placement region configured for placing a token; and
in a case of determining, based on at least one frame of first image in the frames of images, that a game enters a settlement stage, in response to determining, according to at least one frame of second image in the frames of images, that the token in the placement region is changed by a gamer of the game, outputting warning information, wherein the at least one frame of second image is shot in a case where the game enters the settlement stage.

2. The method of claim 1, wherein the game table comprises a game prop operating region, and determining, based on the at least one frame of first image in the frames of images, that the game enters the settlement stage comprises:
acquiring the at least one frame of first image obtained by photographing the game table in a game prop operating stage of the game;
determining game prop information in the game prop operating region based on the at least one frame of first image; and
determining, according to the game prop information, that the game enters the settlement stage.

3. The method of claim 1, wherein determining, according to the at least one frame of second image in the frames of images, that the token in the placement region is changed by the gamer of the game comprises:
detecting token change information of the placement region based on the at least one frame of second image; and
in a case where the token in the placement region is changed and an operator associated with the changed token is the gamer, determining that the token in the placement region is changed by the gamer.

4. The method of claim 1, wherein acquiring the frames of images obtained by photographing the game table comprises:
receiving the frames of images obtained by photographing the game table and respectively sent from at least one camera set up at at least one of a side or top of the game table; or
receiving at least one channel of video obtained by photographing the game table and respectively sent from the at least one camera set up at at least one of the side or the top of the game table, and
extracting the frames of images from the at least one channel of video.

5. The method of claim 1, wherein outputting the warning information comprises: outputting the warning information to a management system.

6. The method of claim 1, further comprising: after outputting the warning information,
determining a first attribute value based on the at least one frame of second image, wherein the first attribute value is an attribute value of the token before the token in the placement region is changed by the gamer;
acquiring at least one frame of third image shot after the at least one frame of second image from the frames of images;
determining a second attribute value based on the at least one frame of third image, wherein the second attribute value is an attribute value of the token after the token in the placement region is changed by the gamer; and
in a case where the first attribute value is the same as the second attribute value, outputting withdrawal information instructing to withdraw a warning.

7. The method of claim 1, further comprising:
acquiring at least one frame of fourth image shot in at least one of a token placement stage or a game prop operating stage of the game from the frames of images; and
outputting prompt information in a case of determining, based on the at least one frame of fourth image, that a token is added to a specified placement region in at least one placement region in the at least one of the token placement stage or the game prop operating stage, wherein the prompt information indicates token addition to the specified placement region.

8. The method of claim 1, wherein in response to determining, according to the at least one frame of second image in the frames of images, that the token in the placement region is changed by the gamer of the game, outputting the warning information comprises at least one of:
in response to determining, according to the at least one frame of second image, that a token is added by the gamer of the game to a placement region of a winner, outputting first warning information, wherein the first warning information indicates token addition of the gamer to the placement region of the winner; or
in response to determining, according to the at least one frame of second image, that a token is taken away by the gamer of the game from a placement region of a loser, outputting second warning information, wherein the second warning information indicates token takeaway of the gamer from the placement region of the loser.

9. The method of claim 3, wherein detecting the token change information of the placement region based on the at least one frame of second image comprises:
determining an attribute value of a first token in the placement region based on a first subimage in the at least one frame of second image;
acquiring a second subimage shot after the first subimage from the at least one frame of second image;
acquiring a third subimage shot after the second subimage from the at least one frame of second image in a case of determining that an operator associated with the token in the placement region in the second subimage is the gamer; and
determining an attribute value of a second token in the placement region in the third subimage;
wherein in a case where the token in the placement region is changed and the operator associated with the changed token is the gamer, determining that the token in the placement region is changed by the gamer comprises:
in a case where the attribute value of the first token is different from the attribute value of the second token and the operator associated with the token in the placement region is the gamer, determining that the token in the placement region is changed by the gamer.

10. The method of claim 1, further comprising:
determining an attribute value of a third token in the placement region based on a fourth subimage in the at least one frame of second image;
acquiring a fifth subimage shot after the fourth subimage from the at least one frame of second image;
in a case of determining that an operator associated with the token in the placement region in the fifth subimage is a game controller, acquiring a sixth subimage shot after the fifth subimage from the at least one frame of second image;
determining an attribute value of a fourth token in the placement region in the sixth subimage; and
in a case where the attribute value of the third token is different from the attribute value of the fourth token, determining that the token in the placement region is changed by the game controller.

11. The method of claim 1, wherein in response to determining, according to the at least one frame of second image in the frames of images, that the token in the placement region is changed by the gamer of the game, outputting the warning information comprises:
in response to determining, based on the at least one frame of second image, that a token is added by the gamer of the game to the placement region of a winner after all tokens in the placement region of the winner are cleared, outputting third warning information, where the third warning information indicates that token addition of the gamer to the placement region of the winner after the all tokens in the placement region of the winner are cleared.

12. The method of claim 3, wherein detecting the token change information of the placement region based on the at least one frame of second image comprises:
in a case of determining, based on a seventh subimage in the at least one frame of second image, that the token in the placement region is cleared in the seventh subimage, acquiring an eighth subimage shot after a seventh subimage from the at least one frame of second image;
in a case of determining that an operator associated with the token in the placement region in the eighth subimage is the gamer, acquiring a ninth subimage shot after the eighth subimage from the at least one frame of second image; and
in a case where the placement region has a token in the ninth subimage, determining that the token change information of the placement region comprises addition of a new token after the token is cleared;
wherein in a case where the token in the placement region is changed and the operator associated with the changed token is the gamer, determining that the token in the placement region is changed by the gamer comprises:
in a case of determining that the new token is added after the token in the placement region is cleared and an operator associated with the token in the placement region is the gamer, determining that the token in the placement region is changed by the gamer.

13. A warning device, comprising:
a memory, configured to store a computer program capable of running in a processor; and
the processor, configured to:
acquire a plurality of frames of images obtained by photographing a game table, wherein the game table comprises a placement region configured for placing a token; and
in a case of determining, based on at least one frame of first image in the frames of images, that a game enters a settlement stage, in response to determining, according to at least one frame of second image in the frames of images, that the token in the placement region is changed by a gamer of the game, output warning information, wherein the at least one frame of second image is shot in a case where the game enters the settlement stage.

14. The warning device of claim 13, wherein the game table comprises a game prop operating region, and the processor is specifically configured to:
acquire the at least one frame of first image obtained by photographing the game table in a game prop operating stage of the game;
determine game prop information in the game prop operating region based on the at least one frame of first image; and
determine, according to the game prop information, that the game enters the settlement stage.

15. The warning device of claim 13, wherein the processor is specifically configured to:
detect token change information of the placement region based on the at least one frame of second image; and
in a case where the token in the placement region is changed and an operator associated with the changed token is the gamer, determine that the token in the placement region is changed by the gamer.

16. The warning device of claim 13, wherein the processor is configured to:
receive the frames of images obtained by photographing the game table and respectively sent from at least one camera set up at at least one of a side or top of the game table; or
receiving at least one channel of video obtained by photographing the game table and respectively sent from the at least one camera set up at at least one of the side or the top of the game table, and extracting the frames of images from the at least one channel of video.

17. The warning device of claim 13, wherein the processor is specifically configured to: output the warning information to a management system.

18. The warning device of claim 13, wherein the processor is further configured to: after outputting the warning information,
determine a first attribute value based on the at least one frame of second image, wherein the first attribute value is an attribute value of the token before the token in the placement region is changed by the gamer;
acquire at least one frame of third image shot after the at least one frame of second image from the frames of images;
determine a second attribute value based on the at least one frame of third image, wherein the second attribute value is an attribute value of the token after the token in the placement region is changed by the gamer; and
in a case where the first attribute value is the same as the second attribute value, output withdrawal information instructing to withdraw a warning.

19. The warning device of claim 13, wherein the processor is further configured to:
acquire at least one frame of fourth image shot in at least one of a token placement stage or a game prop operating stage of the game from the frames of images; and
output prompt information in a case of determining, based on the at least one frame of fourth image, that a token is added to a specified placement region in at least one placement region in the at least one of the token placement stage or the game prop operating stage, wherein the prompt information indicates token addition to the specified placement region.

20. A nonvolatile computer-readable storage medium, storing one or more programs, wherein the one or more programs are executable by one or more processors to implement a warning method, the method comprising:
acquiring a plurality of frames of images obtained by photographing a game table, wherein the game table comprises a placement region configured for placing a token; and
in a case of determining, based on at least one frame of first image in the frames of images, that a game enters a settlement stage, in response to determining, according to at least one frame of second image in the frames of images, that the token in the placement region is changed by a gamer of the game, outputting warning information, wherein the at least one frame of second image is shot in a case where the game enters the settlement stage.
